(19) United States
(12) Patent Application Publication
(10) Pub. No.: US 2022/0086350 A1
(43) Pub. Date: Mar. 17, 2022

(54) Image Generation Method and Apparatus, Terminal and Corresponding Storage Medium

(71) Applicant: KANDAO TECHNOLOGY CO., LTD., Guangdong (CN)

(72) Inventors: Fangqi GAO, Shenzhen (CN); Xiaoliang WANG, Shenzhen (CN); Guoqiang LI, Shenzhen (CN)

(73) Assignee: KANDAO TECHNOLOGY CO., LTD., Guangdong (CN)

(21) Appl. No.: 17/419,299

(22) PCT Filed: Dec. 26, 2019
(86) PCT No.: PCT/CN2019/128665

§ 371 Date: Jun. 29, 2021

(30) Foreign Application Priority Data
Dec. 29, 2018 (CN) 201811640334.X

(51) Int. Cl. H04N 5/232; G06T 7/11; G06T 7/70

(52) U.S. Cl. CPC H04N 5/23267; G06T 7/11; H04N 5/23229; H04N 5/23258; G06T 7/70

(57) ABSTRACT

An image generation method is provided. The image generation method includes the steps of acquiring a planimetric taken input image, and segmenting the planimetric taken input image into a plurality of planimetric image regions; acquiring a region exposure time point of each planimetric image region and a lens attitude of a corresponding taking lens at the region exposure time point; correcting a planimetric position coordinate of each planimetric image region according to the lens attitude of the taking lens at the region exposure time point and a lens attitude of the taking lens at an intermediate time point of image exposure; and generating a planimetric taken output image based on the corrected planimetric position coordinates of the planimetric image regions.

### BACKGROUND

### Technical Field

The present disclosure relates to the technical field of image processing, and particularly relates to an image generation method and apparatus, a terminal and a corresponding storage medium.

### Description of Related Art

With the development of science and technology, people have higher and higher requirements for handheld shooting terminals, such as cameras or camcorders. For example, users hope that the sharpness of taken pictures will be higher and higher, and hope that the difficulty in shooting operations will be lower and lower.

Existing handheld shooting terminals on the market often use a rolling shutter, that is, each row on a sensor is exposed sequentially. In this way, when a user holds the shooting terminal for rapid rotation, objects in images taken by the shooting terminal may possibly generate a distortion effect. A shooting result is that an object in an image may be “tilted”, “wobbled” or “partially exposed”, etc. For example, a “Jelly” effect occurs when a video is played.

Therefore, it is necessary to provide an image generation method and apparatus to solve the problems existing in the prior art.

### SUMMARY

The embodiments of the present disclosure provide an image generation method and apparatus capable of effectively eliminating an image distortion phenomenon or a “Jelly” effect, so as to solve the technical problem that an image generated by an existing image generation method and apparatus is easy to distort or has the “Jelly” effect.

The embodiments of the present disclosure provide an image generation method, including the following steps:

acquiring a planimetric taken input image, and segmenting the planimetric taken input image into a plurality of planimetric image regions, wherein each planimetric image region includes a planimetric position coordinate used for indicating a position of the planimetric image region in the planimetric taken input image;

acquiring a region exposure time point of each planimetric image region and a lens attitude of a corresponding taking lens at the region exposure time point;

correcting the planimetric position coordinate of each planimetric image region according to the lens attitude of the taking lens at the region exposure time point and a lens attitude of the taking lens at an intermediate time point of image exposure; and

generating a planimetric taken output image based on the corrected planimetric position coordinates of the planimetric image regions.

In one embodiment, the step of acquiring the region exposure time point of each planimetric image region comprises:

determining the region exposure time point of each planimetric image region according to an image exposure start time point of the planimetric taken input image, a total image exposure duration and the planimetric position coordinate of each planimetric image region.

In one embodiment, the step of acquiring the lens attitude of the taking lens at the region exposure time point comprises:

acquiring the lens attitude of the taking lens at the region exposure time point according to measurement data of a gyroscope.

In one embodiment, the step of acquiring the lens attitude of the taking lens at the region exposure time point comprises:

acquiring a lens attitude change trend of the taking lens in a total image exposure duration according to the measurement data of the gyroscope, and determining the lens attitude corresponding to the region exposure time point of each planimetric image region from the lens attitude change trend.

In one embodiment, the step of correcting the planimetric position coordinate of each planimetric image region according to the lens attitude of the taking lens at the region exposure time point and the lens attitude of the taking lens at the intermediate time point of image exposure comprises:

transforming the planimetric position coordinate of each planimetric image region into a spherical position coordinate of a corresponding spherical image region according to parameters of the taking lens;

correcting the spherical position coordinate of the corresponding spherical image region according to the lens attitude of the taking lens at the region exposure time point and the lens attitude of the taking lens at the intermediate time point of image exposure;

transforming the corrected spherical position coordinates of the spherical image regions into the corrected planimetric position coordinates of the planimetric image regions.

In one embodiment, the planimetric position coordinate of each planimetric image region is transformed into the spherical position coordinate of the corresponding spherical image region through the following formulas:

$$r = \sqrt[2]{{( x - cx )}^{2} + {( y - cy )}^{2}} ;$$

$${θ}_{d} = \frac{r}{focal} ;$$

$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$

wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

In one embodiment, the spherical position coordinate of the corresponding spherical image region is corrected through the following formula:

$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$

wherein (X, Y, Z) is the spherical position coordinate of the corresponding spherical image region; (\hat{X}, Ŷ, \hat{Z}) is the corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

In one embodiment, the corrected spherical position coordinates of the spherical image regions are transformed into the corrected planimetric position coordinates of the planimetric image regions through the following formulas:

$$θ = {tan}^{- 1} \frac{\sqrt[2]{{\hat{X}}^{2} + {\hat{Y}}^{2}}}{\hat{Z}} ;$$

$${θ}_{d} = distort ( θ ) ;$$

$$r = focal * {θ}_{d} ; \\ [ \begin{matrix}\hat{x} \\ \hat{y}\end{matrix} ] = e * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$

wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region; distort is a distortion function; and focal is a calibration focal length of the taking lens.

The embodiments of the present disclosure further provide an image generation apparatus, including:

a planimetric image region segmentation module, configured to acquire a planimetric taken input image, and segment the planimetric taken input image into a plurality of planimetric image regions, wherein each planimetric image region includes a planimetric position coordinate used for indicating a position of the planimetric image region in the planimetric taken input image;

a time attitude acquisition module, configured to acquire a region exposure time point of each planimetric image region and a lens attitude of a corresponding taking lens at the region exposure time point;

a planimetric image region correction module, configured to correct the planimetric position coordinate of each planimetric image region according to the lens attitude of the taking lens at the region exposure time point and a lens attitude of the taking lens at an intermediate time point of image exposure; and

an image output module, configured to generate a planimetric taken output image based on the corrected planimetric position coordinates of the planimetric image regions.

In one embodiment, the time attitude acquisition module further configured to:

determining the region exposure time point of each planimetric image region according to an image exposure start time point of the planimetric taken input image, a total image exposure duration and the planimetric position coordinate of each planimetric image region.

In one embodiment, the time attitude acquisition module further configured to:

acquiring the lens attitude of the taking lens at the region exposure time point according to measurement data of a gyroscope.

In one embodiment, the time attitude acquisition module further configured to:

acquiring a lens attitude change trend of the taking lens in a total image exposure duration according to the measurement data of the gyroscope, and determining the lens attitude corresponding to the region exposure time point of each planimetric image region from the lens attitude change trend.

In one embodiment, the planimetric image region correction module further configured to:

transforming the planimetric position coordinate of each planimetric image region into a spherical position coordinate of a corresponding spherical image region according to parameters of the taking lens;

correcting the spherical position coordinate of the corresponding spherical image region according to the lens attitude of the taking lens at the region exposure time point and the lens attitude of the taking lens at the intermediate time point of image exposure;

transforming the corrected spherical position coordinates of the spherical image regions into the corrected planimetric position coordinates of the planimetric image regions.

In one embodiment, the planimetric image region correction module configured to:

transforming the planimetric position coordinate of each planimetric image region into a spherical position coordinate of a corresponding spherical image region through the following formulas:

$$r = \sqrt[2]{{( x - cx )}^{2} + {( y - cy )}^{2}} ;$$

$${θ}_{d} = \frac{r}{focal} ;$$

$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$

wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

In one embodiment, the planimetric image region correction module configured to:

correcting the spherical position coordinate of the corresponding spherical image region through the following formulas:

$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$

wherein (X, Y, Z) is the spherical position coordinate of the corresponding spherical image region; (\hat{X}, Ŷ, \hat{Z}) is the corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

In one embodiment, the planimetric image region correction module configured to:

transforming the corrected spherical position coordinates of the spherical image regions into the corrected planimetric position coordinates of the planimetric image regions through the following formulas:

$$θ = {tan}^{- 1} \frac{\sqrt[2]{{\hat{X}}^{2} + {\hat{Y}}^{2}}}{\hat{Z}} ;$$

$${θ}_{d} = distort ( θ ) ;$$

$$r = focal * {θ}_{d} ; \\ [ \begin{matrix}\hat{x} \\ \hat{y}\end{matrix} ] = r * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$

wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region; distort is a distortion function; and focal is a calibration focal length of the taking lens.

The embodiments of the present disclosure further provide a computer-readable storage medium, having a processor executable instruction stored therein. The instruction is loaded by one or more processors to execute an image generation method comprising the following steps:

acquiring a planimetric taken input image, and segmenting the planimetric taken input image into a plurality of planimetric image regions, wherein each planimetric image region includes a planimetric position coordinate used for indicating a position of the planimetric image region in the planimetric taken input image;

acquiring a region exposure time point of each planimetric image region and a lens attitude of a corresponding taking lens at the region exposure time point;

correcting the planimetric position coordinate of each planimetric image region according to the lens attitude of the taking lens at the region exposure time point and a lens attitude of the taking lens at an intermediate time point of image exposure; and

generating a planimetric taken output image based on the corrected planimetric position coordinates of the planimetric image regions.

The embodiments of the present disclosure further provide a terminal which includes a processor and a memory. The memory stores a plurality of instructions. The processor loads the instructions from the memory to execute an image generation method comprising the following steps:

acquiring a planimetric taken input image, and segmenting the planimetric taken input image into a plurality of planimetric image regions, wherein each planimetric image region includes a planimetric position coordinate used for indicating a position of the planimetric image region in the planimetric taken input image;

acquiring a region exposure time point of each planimetric image region and a lens attitude of a corresponding taking lens at the region exposure time point;

correcting the planimetric position coordinate of each planimetric image region according to the lens attitude of the taking lens at the region exposure time point and a lens attitude of the taking lens at an intermediate time point of image exposure; and

generating a planimetric taken output image based on the corrected planimetric position coordinates of the planimetric image regions.

Compared with the image generation method and the image generation apparatus in the prior art, the image generation method and the image generation apparatus of the present disclosure correct the planimetric position coordinates of the planimetric image regions based on the lens attitudes at the region exposure time points, so that the generated planimetric taken output image will not distort or generate the “Jelly” effect. The technical problem that an image generated by the existing image generation method and apparatus is easy to distort or has the “Jelly” effect is effectively solved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flow diagram of an embodiment of an image generation method of the present disclosure;

FIG. 2 is a flow diagram of the step S103 of an embodiment of an image generation method of the present disclosure;

FIG. 3 is a schematic structural diagram of an embodiment of an image generation apparatus of the present disclosure.

FIG. 4 is a schematic diagram showing a structure of a working environment of an electronic device where the image generation apparatus provided by the present invention is located.

### DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all the embodiments. Based on the embodiments in the present invention, all other embodiments obtained by those skilled in the art without creative work shall fall within the scope of protection of the present invention.

An image generation method and an image generation apparatus of the present disclosure may be disposed in any electronic device having a camera and are used to output images taken by the camera. The camera of the electronic device exposes an image with a rolling shutter. An output image taken by the electronic device of the present disclosure can effectively eliminate the image distortion phenomenon or the “Jelly” effect. The electronic device includes, but is not limited to, a wearable device, a head-mounted device, a medical and health platform, a personal computer, a server computer, a handheld or laptop device, a mobile device (such as a mobile phone, a personal digital assistant (PDA) and a media player), a multi-processor system, a consumer electronic device, a small computer, a large computer, a distributed computing environment including any of the above systems or devices, etc. The electronic device is preferably a shooting terminal having a rolling shutter camera, and the shooting terminal can output images or videos that do not have the image distortion phenomenon or the “Jelly” effect, so that the quality of the output images or output videos is improved.

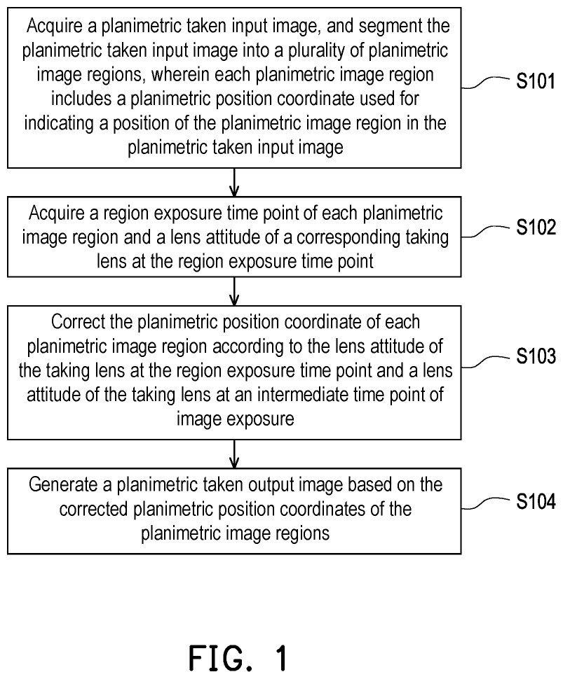

Referring to FIG. 1, FIG. 1 is a flow diagram of an embodiment of an image generation method of the present disclosure. The image generation method of the present embodiment may be implemented by using the foregoing electronic device. The image generation method includes:

step S101, a planimetric taken input image is acquired, and the planimetric taken input image is segmented into a plurality of planimetric image regions, wherein each planimetric image region includes a planimetric position coordinate used for indicating a position of the planimetric image region in the planimetric taken input image;

step S102, a region exposure time point of each planimetric image region and a lens attitude of a corresponding taking lens at the region exposure time point are acquired;

step S103, the planimetric position coordinate of each planimetric image region is corrected according to the lens attitude of the taking lens at the region exposure time point and a lens attitude of the taking lens at an intermediate time point of image exposure; and

step S104, a planimetric taken output image is generated based on the corrected planimetric position coordinates of the planimetric image regions.

An image generation process of the image generation method of the present embodiment is described in detail below.

In the step S101, an image generation apparatus (such as a shooting terminal having a rolling shutter camera) acquires the planimetric taken input image through a camera. The planimetric taken input image here is a taken image that is taken by the shooting terminal and may generate image distortion.

The region exposure time points of the image regions in the planimetric taken input image are different, so that the image generation apparatus in this step segments the planimetric taken input image into a plurality of planimetric image regions. For example, the planimetric taken input image is segmented into 80*80 grid regions, and each grid corresponds to one planimetric image region.

Each planimetric image region includes the planimetric position coordinate used for indicating the position of the planimetric image region in the planimetric taken input image. In this way, the image generation apparatus may correct each planimetric image region by correcting the planimetric position coordinate, and then correct the whole planimetric taken input image.

In the step S102, the image generation apparatus acquires the region exposure time point of each planimetric image region in the step S101. Specifically, the image generation apparatus may determine the region exposure time point of each planimetric image region according to an image exposure start time point of the planimetric taken input image, a total image exposure duration and the planimetric position coordinate of each planimetric image region. The image exposure start time point here is a time point at which the planimetric taken input image starts to be subjected to image exposure, and the total image exposure duration is a total time length of the image exposure of the planimetric taken input image. The region exposure time point is a time point at which each planimetric image region is subjected to image exposure.

If the image exposure start time point of the planimetric taken input image is t₀, the total image exposure duration of the planimetric taken input image is tₑₓₚ. If the planimetric position coordinate of each planimetric image region is located in the center of the whole planimetric taken input image, the region exposure time point of the planimetric image region is

$${t}_{k} = {t}_{a} + \frac{{t}_{exp}}{2} .$$

Later, the image generation apparatus acquires the lens attitude of the corresponding taking lens at the region exposure time point. Specifically, the image generation apparatus may acquire the lens attitude of the taking lens at the region exposure time point according to measurement data of a gyroscope. The gyroscope here may collect the lens attitude of the taking lens at a collection frequency of 200 Hz. In this way, the image generation apparatus may acquire a lens attitude change trend of the taking lens in the total image exposure duration, and may determine the lens attitude corresponding to the region exposure time point of each planimetric image region from the lens attitude change trend by means of interpolation and the like.

In the step S103, the image generation apparatus corrects the planimetric position coordinate of each planimetric image region, which is acquired in the step S101, according to the lens attitude of the taking lens at the region exposure time point, which is acquired in the step S102, and the lens attitude of the taking lens at the intermediate time point of image exposure.

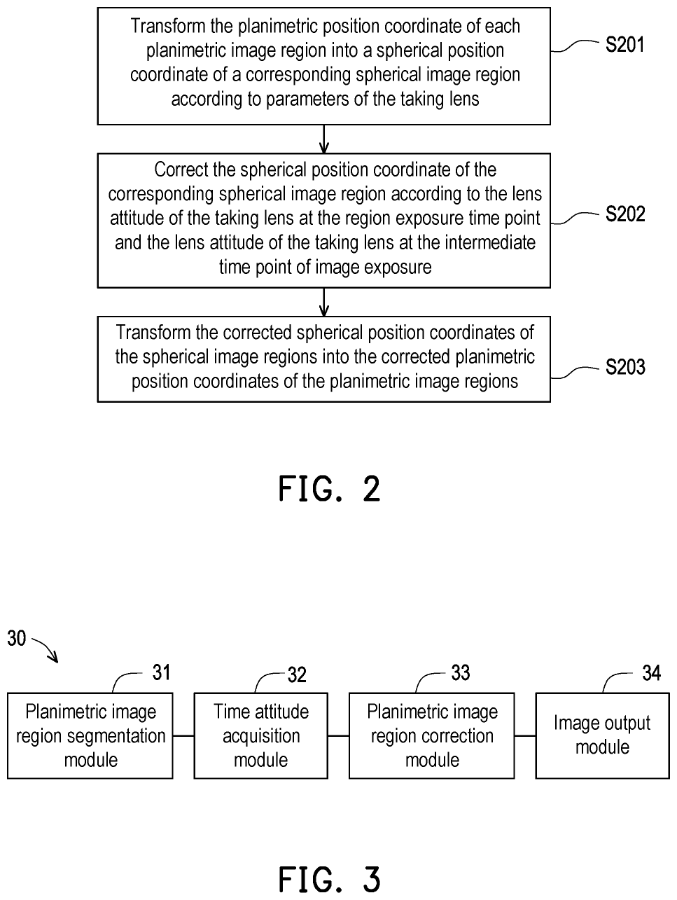

Specifically, referring to FIG. 2, FIG. 2 is a flow diagram of the step S103 of an embodiment of an image generation method of the present disclosure. The step S103 includes:

step S201, the image generation apparatus transforms the planimetric position coordinate of each planimetric image region into a spherical position coordinate of a corresponding spherical image region according to parameters of the taking lens. The spherical position coordinates may be conveniently corrected through the lens attitudes, so that in this step, the image generation apparatus transforms the planimetric position coordinates into the spherical position coordinates that are easy to correct.

Specifically, the planimetric position coordinate of each planimetric image region may be transformed into the spherical position coordinate of the corresponding spherical image region through the following formulas;

$$r = \sqrt[2]{{( x - cx )}^{2} + {( y - cy )}^{2}} ;$$

$${θ}_{d} = \frac{r}{focal} ;$$

$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$

wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

step S202, the image generation apparatus corrects the spherical position coordinate of the corresponding spherical image region according to the lens attitude of the taking lens at the region exposure time point and the lens attitude of the taking lens at an intermediate time point of image exposure.

Specifically, the spherical position coordinate of the corresponding spherical image region may be corrected through the following formulas;

$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$

wherein (X, Y, Z) is the spherical position coordinate of the corresponding spherical image region; (\hat{X}, Ŷ, \hat{Z}) is a corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

The lens attitude matrix R_{c} of the taking lens at the intermediate time point of image exposure and the lens attitude matrix Rₖ of the taking lens at the region exposure time point may be both calculated through the measurement data of the gyroscope in the step S102.

step S203, the image generation apparatus transforms the corrected spherical position coordinates of the spherical image regions into the corrected planimetric position coordinates of the planimetric image regions to facilitate outputting of the planimetric taken image.

Specifically, the corrected spherical position coordinates of the spherical image regions may be transformed into the corrected planimetric position coordinates of the planimetric image regions through the following formulas:

$$θ = {tan}^{- 1} \frac{\sqrt[2]{{\hat{X}}^{2} + {\hat{Y}}^{2}}}{\hat{Z}} ;$$

$${θ}_{d} = distort ( θ ) ;$$

$$r = focal * {θ}_{d} ; \\ [ \begin{matrix}\hat{x} \\ \hat{y}\end{matrix} ] = r * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$

wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region; distort is a distortion function; and focal is a calibration focal length of the taking lens.

In the step S104, the image generation apparatus generates the planimetric output image based on the corrected planimetric position coordinates of the planimetric image regions, which are acquired in the step S103, and the planimetric output image may well eliminate the image distortion phenomenon or the “Jelly” effect.

In this way, the image generation process of the image generation method of the present embodiment is completed.

The image generation method of the present embodiment corrects the planimetric position coordinates of the planimetric image regions based on the lens attitudes at the region exposure time points, so that the generated planimetric taken output image will not have the image distortion phenomenon or the “Jelly” effect.

The present disclosure further provides an image generation apparatus. Referring to FIG. 3, FIG. 3 is a schematic structural diagram of an embodiment of an image generation apparatus of the present disclosure. The image generation apparatus 30 of the present embodiment includes a planimetric image region segmentation module 31, a time attitude acquisition module 32, a planimetric image region correction module 33 and an image output module 34.

The planimetric image region segmentation module 31 is configured to acquire a planimetric taken input image, and segment the planimetric taken input image into a plurality of planimetric image regions, wherein each planimetric image region includes a planimetric position coordinate used for indicating a position of the planimetric image region in the planimetric taken input image; the time attitude acquisition module 32 is configured to acquire a region exposure time point of each planimetric image region and a lens attitude of a corresponding taking lens at the region exposure time point; the planimetric image region correction module 33 is configured to correct the planimetric position coordinate of each planimetric image region according to the lens attitude of the taking lens at the region exposure time point and a lens attitude of the taking lens at an intermediate time point of image exposure; and the image output module 34 is configured to generate a planimetric taken output image based on the corrected planimetric position coordinates of the planimetric image regions.

When the image generation apparatus 30 of the present embodiment is used, firstly, the planimetric image region segmentation module 31 acquires the planimetric taken input image through a camera. The planimetric taken input image here is a taken image that is taken by the shooting terminal and may generate image distortion.

The region exposure time points of the image regions in the planimetric taken input image are different, so that the planimetric image region segmentation module 31 segments the planimetric taken input image into a plurality of planimetric image regions. For example, the planimetric taken input image is segmented into 80*80 grid regions, and each grid corresponds to one planimetric image region.

Each planimetric image region includes the planimetric position coordinate used for indicating the position of the planimetric image region in the planimetric taken input image. In this way, the image generation apparatus may correct each planimetric image region by correcting the planimetric position coordinate, and then correct the whole planimetric taken input image.

Later, the time attitude acquisition module 32 acquires the region exposure time point of each planimetric image region. Specifically, the time attitude acquisition module 32 may determine the region exposure time point of each planimetric image region according to an image exposure start time point of the planimetric taken input image, a total image exposure duration and the planimetric position coordinate of each planimetric image region. The image exposure start time point here is a time point at which the planimetric taken input image starts to be subjected to image exposure, and the total image exposure duration is a total time length of the image exposure of the planimetric taken input image. The region exposure time point is a time point at which each planimetric image region is subjected to image exposure.

If the image exposure start time point of the planimetric taken input image is t₀, the total image exposure duration of the planimetric taken input image is tₑₓₚ. If the planimetric position coordinate of each planimetric image region is located in the center of the whole planimetric taken input image, the region exposure time point of the planimetric image region is

$${t}_{k} = {t}_{o} + \frac{{t}_{exp}}{2} .$$

Then, the planimetric image region correction module 33 corrects the planimetric position coordinate of each planimetric image region, which is acquired by the planimetric image region segmentation module 31, according to the lens attitude of the taking lens at the region exposure time point, which is acquired by the time attitude acquisition module 32, and the lens attitude of the taking lens at the intermediate time point of image exposure.

The specific flow of correction includes:

I, the planimetric image region correction module 33 transforms the planimetric position coordinate of each planimetric image region into a spherical position coordinate of a corresponding spherical image region according to parameters of the taking lens. The spherical position coordinates may be conveniently corrected through the lens attitudes, so that in this step, the planimetric image region correction module 33 transforms the planimetric position coordinates into the spherical position coordinates that are easy to correct.

Specifically, the planimetric position coordinate of each planimetric image region may be transformed into the spherical position coordinate of the corresponding spherical image region through the following formulas;

$$r = \sqrt[2]{{( x - cx )}^{2} + {( y - cy )}^{2}} ;$$

$${θ}_{d} = \frac{r}{focal} ;$$

$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$

wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

II, the planimetric image region correction module 33 corrects the spherical position coordinate of the corresponding spherical image region according to the lens attitude of the taking lens at the region exposure time point and the lens attitude of the taking lens at an intermediate time point of image exposure.

Specifically, the spherical position coordinate of the corresponding spherical image region may be corrected through the following formulas;

$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$

wherein (X, Y, Z) is the spherical position coordinate of the corresponding spherical image region; (\hat{X}, Ŷ, \hat{Z}) is a corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

The lens attitude matrix R_{c} of the taking lens at the intermediate time point of image exposure and the lens attitude matrix Rₖ of the taking lens at the region exposure time point may be both calculated through the measurement data of the gyroscope.

III, the planimetric image region correction module 33 transforms the corrected spherical position coordinates of the spherical image regions into the corrected planimetric position coordinates of the planimetric image regions to facilitate outputting of the planimetric taken image.

Specifically, the corrected spherical position coordinates of the spherical image regions may be transformed into the corrected planimetric position coordinates of the planimetric image regions through the following formulas;

$$θ = {tan}^{- 1} \frac{\sqrt[2]{{\hat{X}}^{2} + {\hat{Y}}^{2}}}{\hat{Z}} ;$$

$${θ}_{d} = distort ( θ ) ;$$

$$r = focal * {θ}_{d} ; \\ [ \begin{matrix}\hat{x} \\ \hat{y}\end{matrix} ] = r * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$

wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region; distort is a distortion function; and focal is a calibration focal length of the taking lens.

Finally, the image output module 34 generates the planimetric output image based on the corrected planimetric position coordinates of the planimetric image regions, and the planimetric output image may well eliminate the image distortion phenomenon or the “Jelly” effect.

In this way, the image generation process of the image generation apparatus 30 of the present embodiment is completed.

The image generation apparatus of the present embodiment corrects the planimetric position coordinates of the planimetric image regions based on the lens attitudes at the region exposure time points, so that the generated planimetric taken output image will not have the image distortion phenomenon or the “Jelly” effect.

The image generation method and the image generation apparatus of the present disclosure correct the planimetric position coordinates of the planimetric image regions based on the lens attitudes at the region exposure time points, so that the generated planimetric taken output image will not distort or generate the “Jelly” effect. The technical problem that an image generated by the existing image generation method and apparatus is easy to distort or has the “Jelly” effect is effectively solved.

Terms such as “component”, “module”, “system”, “interface” and “process” used in the present application generally refer to computer-relevant entities: hardware, a combination of hardware and software, software or software being executed. For example, the component can be, but not limited to a process running on a processor, the processor, an object, an executable application, an executed thread, a program and/or a computer. Shown by the drawings, an application running on a controller and the controller can be both components. One or more components can exist in the executed process and/or thread and can be located on one computer and/or distributed between two computers or among more computers.

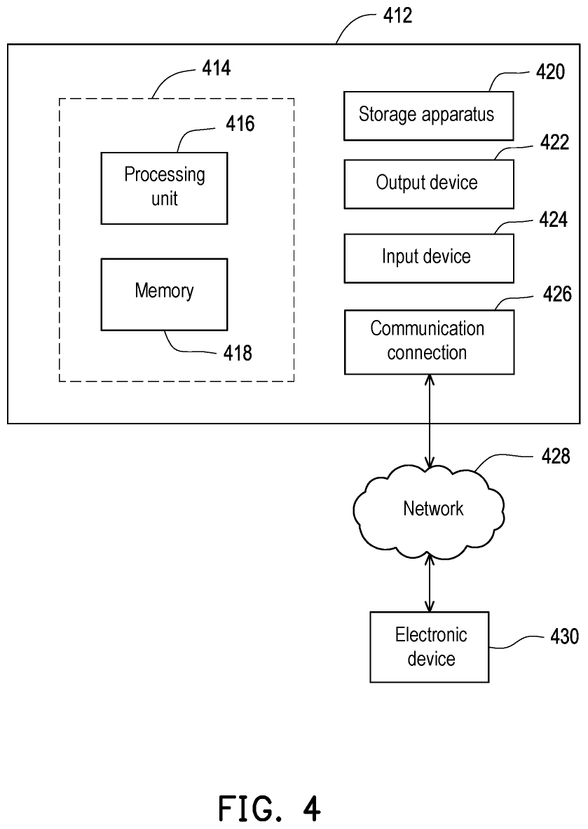

FIG. 4 and the subsequent discussion provide brief and general descriptions for a working environment of an electronic device where the image generation apparatus provided by the present invention is located. The working environment shown in FIG. 4 is only an example of an appropriate working environment and is not intended to constitute any limitations on the range of applications or functions of the working environment. An exemplary electronic device 412 comprises, but is not limited to, a wearable device, a head-mounted device, a medical health platform, a personal computer, a server computer, a handheld or laptop device, a mobile device (such as a mobile phone, a personal digital assistant (PDA) and a media player), a multi-processor system, a consumer electronic device, a small-size computer, a large-scale computer, and a distributed computing environment comprising any of above-mentioned systems or devices.

Although not required, the embodiment is described under the general background that “computer readable instructions” are executed by one or more electronic devices. The computer readable instructions can be distributed by a computer readable medium (discussed below). The computer readable instructions are implemented as program modules such as functions, objects, application programming interfaces (API) and data structures for executing specific tasks or implementing specific abstract data types. Typically, the functions of the computer readable instructions can be randomly combined or distributed in various environments.

FIG. 4 illustrates an example of an electronic device 412 comprising one or more embodiments of the image generation apparatus provided by the present invention. In one configuration, the electronic device 412 comprises at least one processing unit 416 and a memory 418. According to the exact configuration and type of the electronic device, the memory 418 can be a volatile memory (such as an RAM), a non-volatile memory (such as an ROM and a flash memory) or a certain combination of the volatile memory and the non-volatile memory. The configuration is shown as a dotted line 414 in FIG. 4.

In other embodiments, the electronic device 412 can comprise additional features and/or functions. For example, the device 412 can further comprise an additional storage apparatus (for example, removable and/or non-removable), and comprises, but is not limited to, a magnetic storage apparatus and an optical storage apparatus. The additional storage apparatus is illustrated as a storage apparatus 420 in FIG. 4. In one embodiment, the computer readable instructions for implementing one or more embodiments provided herein can be stored in the storage apparatus 420. The storage apparatus 420 can further store other computer readable instructions for implementing an operating system and an application. The computer readable instructions can be loaded into the memory 418 so as to be executed by, for example, the processing unit 416.

The term “computer readable medium” used herein comprises a computer storage medium. The computer storage medium comprises a volatile medium, a non-volatile medium, a removable medium and a non-removable medium implemented by using any method or technology for storing information such as the computer readable instructions or other data. The memory 418 and the storage apparatus 420 are examples of the computer storage medium. The computer storage medium comprises, but is not limited to, an RAM, an ROM, an EEPROM, a flash memory or other memory technologies, a CD-ROM, a digital video disk (DVD) or other optical storage apparatuses, a cassette tape, a magnetic tape, a magnetic disk storage apparatus or other magnetic storage devices, or any other media which can be used for storing desired information and can be accessed by the electronic device 412. Any of such computer storage media can be a part of the electronic device 412.

The electronic device 412 can further comprise a communication connection 426 allowing the electronic device 412 to communicate with other devices. The communication connection 426 can comprise, but not limited to, a modem, a network interface card (NIC), an integrated network interface, a radio frequency transmitter/receiver, an infrared port, a USB connection or other interfaces for connecting the electronic device 412 to other electronic devices. The communication connection 426 can comprise wired connection or wireless connection. The communication connection 426 is capable of transmitting and/or receiving a communication medium.

The term “computer readable medium” can comprise a communication medium. The communication medium typically comprises computer readable instructions or other data in “modulated data signals” such as carriers or other transmission mechanisms, and comprises any information delivery medium. The term “modulated data signals” can comprise such signals that one or more of signal features are set or changed in a manner of encoding information into the signals.

The electronic device 412 can comprise an input device 424 such as a keyboard, a mouse, a pen, a voice input device, a touch input device, an infrared camera, a video input device and/or any other input devices. The device 412 can further comprise an output device 422 such as one or more displays, loudspeakers, printers and/or any other output devices. The input device 424 and the output device 422 can be connected to the electronic device 412 by wired connection, wireless connection or any combination thereof. In one embodiment, an input device or an output device of another electronic device can be used as the input device 424 or the output device 422 of the electronic device 412.

Components of the electronic device 412 can be connected by various interconnections (such as a bus). Such interconnections can comprise a peripheral component interconnect (PCI) (such as a quick PCI), a universal serial bus (USB), a fire wire (IEEE 1394), an optical bus structure and the like. In another embodiment, the components of the electronic device 412 can be interconnected by a network. For example, the memory 418 can be composed of a plurality of physical memory units located on different physical positions and interconnected by the network.

It will be appreciated by those skilled in the art that storage devices for storing the computer readable instructions can be distributed across the network. For example, an electronic device 430 which can be accessed by a network 428 is capable of storing computer readable instructions for implementing one or more embodiments provided by the present invention. The electronic device 412 is capable of accessing the electronic device 430 and downloading a part or all of the computer readable instructions to be executed. Alternatively, the electronic device 412 is capable of downloading a plurality of computer readable instructions as required, or some instructions can be executed on the electronic device 412, and some instructions can be executed on the electronic device 430.

Various operations in the embodiments are provided herein. In one embodiment, the one or more operations can constitute one or more computer readable instructions stored in the computer readable medium, and a computing device will be enabled to execute the operations when the computer readable instructions are executed by the electronic device. The order of describing some or all of the operations should not be construed as implying that these operations have to be relevant to the order, and will be understood, by those skilled in the art, as an alternative order having benefits of this description. Moreover, it should be understood that not all the operations have to exist in each embodiment provided herein.

Moreover, although the present disclosure has been shown and described relative to one or more implementation modes, those skill in the art will envision equivalent variations and modifications based on reading and understanding of this description and the accompanying drawings. All of such modifications and variations are included in the present disclosure and are only limited by the scope of the appended claims. Particularly, with respect to various functions executed by the above-mentioned components (such as elements and resources), terms for describing such components are intended to correspond to any component (unless other indicated) for executing specified functions of the components (for example, the components are functionally equivalent), even if the structures of the components are different from the disclosed structures for executing the functions in an exemplary implementation mode of the present disclosure shown herein. In addition, although a specific feature in the present disclosure has been disclosed relative to only one in several implementation modes, the feature can be combined with one or more other features in other implementation modes which can be desired and beneficial for a given or specific application. Moreover, as for terms “comprising”, “having” and “containing” or variants thereof applied to the detailed description or claims, such terms means inclusion in a manner similar to the term “including”.

All the functional units in the embodiments of the present invention can be integrated in a processing module, or each unit separately and physically exists, or two or more units are integrated in a module. The above-mentioned integrated module can be achieved in a form of either hardware or a software functional module. If the integrated module is achieved in the form of the software functional module and is sold or used as an independent product, the integrated module can also be stored in a computer readable storage medium. The above-mentioned storage medium can be a read-only memory, a magnetic disk or an optical disk and the like. All of the above-mentioned apparatuses and systems can execute the methods in the corresponding embodiments of the methods.

In conclusion, although the present invention has been disclosed as above with the embodiments, serial numbers in front of the embodiments are merely used to facilitate description, rather than limit the order of the embodiments. Moreover, the above-mentioned embodiments are not intended to limit the present invention. Various changes and modifications can be made by those of ordinary skill in the art without departing from the spirit and scope of the present invention, and therefore, the protective scope of the present invention is subject to the scope defined by the claims.

What is claimed is:

1. An image generation method, comprising the following steps:
acquiring a planimetric taken input image, and segmenting the planimetric taken input image into a plurality of planimetric image regions, wherein each planimetric image region includes a planimetric position coordinate used for indicating a position of the planimetric image region in the planimetric taken input image;
acquiring a region exposure time point of each planimetric image region and a lens attitude of a corresponding taking lens at the region exposure time point;
correcting the planimetric position coordinate of each planimetric image region according to the lens attitude of the taking lens at the region exposure time point and a lens attitude of the taking lens at an intermediate time point of image exposure; and
generating a planimetric taken output image based on the corrected planimetric position coordinates of the planimetric image regions.

2. The image generation method according to claim 1, wherein the step of acquiring the region exposure time point of each planimetric image region comprises:
determining the region exposure time point of each planimetric image region according to an image exposure start time point of the planimetric taken input image, a total image exposure duration and the planimetric position coordinate of each planimetric image region.

3. The image generation method according to claim 1, wherein the step of acquiring the lens attitude of the taking lens at the region exposure time point comprises:
acquiring the lens attitude of the taking lens at the region exposure time point according to measurement data of a gyroscope.

4. The image generation method according to claim 3, wherein the step of acquiring the lens attitude of the taking lens at the region exposure time point comprises:
acquiring a lens attitude change trend of the taking lens in a total image exposure duration according to the measurement data of the gyroscope, and determining the lens attitude corresponding to the region exposure time point of each planimetric image region from the lens attitude change trend.

5. The image generation method according to claim 1, wherein the step of correcting the planimetric position coordinate of each planimetric image region according to the lens attitude of the taking lens at the region exposure time point and the lens attitude of the taking lens at the intermediate time point of image exposure comprises:
transforming the planimetric position coordinate of each planimetric image region into a spherical position coordinate of a corresponding spherical image region according to parameters of the taking lens;
correcting the spherical position coordinate of the corresponding spherical image region according to the lens attitude of the taking lens at the region exposure time point and the lens attitude of the taking lens at the intermediate time point of image exposure;
transforming the corrected spherical position coordinates of the spherical image regions into the corrected planimetric position coordinates of the planimetric image regions.

6. The image generation method according to claim 5, wherein the planimetric position coordinate of each planimetric image region is transformed into the spherical position coordinate of the corresponding spherical image region through the following formulas:
$$r = \sqrt[2]{{( x - cx )}^{2} + {( y - cy )}^{2}} ;$$
$${θ}_{d} = \frac{r}{focal} ;$$
$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$
wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

7. The image generation method according to claim 5, wherein the spherical position coordinate of the corresponding spherical image region is corrected through the following formula:
$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$
wherein (X, Y, Z) is the spherical position coordinate of the corresponding spherical image region; (\hat{X}, Ŷ, \hat{Z}) is the corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

8. The image generation method according to claim 5, wherein the corrected spherical position coordinates of the spherical image regions are transformed into the corrected planimetric position coordinates of the planimetric image regions through the following formulas:
$$θ = {tan}^{- 1} \frac{\sqrt[2]{{\hat{X}}^{2} + {\hat{Y}}^{2}}}{\hat{Z}} ;$$
$${θ}_{d} = distort ( θ ) ;$$
$$r = focal * {θ}_{d} ; \\ [ \begin{matrix}\hat{x} \\ \hat{y}\end{matrix} ] = r * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$
wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region; distort is a distortion function; and focal is a calibration focal length of the taking lens.

9. An image generation apparatus, comprising:
a planimetric image region segmentation module, configured to acquire a planimetric taken input image, and segment the planimetric taken input image into a plurality of planimetric image regions, wherein each planimetric image region includes a planimetric position coordinate used for indicating a position of the planimetric image region in the planimetric taken input image;
a time attitude acquisition module, configured to acquire a region exposure time point of each planimetric image region and a lens attitude of a corresponding taking lens at the region exposure time point;
a planimetric image region correction module, configured to correct the planimetric position coordinate of each planimetric image region according to the lens attitude of the taking lens at the region exposure time point and a lens attitude of the taking lens at an intermediate time point of image exposure; and
an image output module, configured to generate a planimetric taken output image based on the corrected planimetric position coordinates of the planimetric image regions.

10. The image generation apparatus according to claim 9, wherein the time attitude acquisition module further configured to:
determining the region exposure time point of each planimetric image region according to an image exposure start time point of the planimetric taken input image, a total image exposure duration and the planimetric position coordinate of each planimetric image region.

11. The image generation apparatus according to claim 9, wherein the time attitude acquisition module further configured to:
acquiring the lens attitude of the taking lens at the region exposure time point according to measurement data of a gyroscope.

12. The image generation apparatus according to claim 11, wherein the time attitude acquisition module further configured to:
acquiring a lens attitude change trend of the taking lens in a total image exposure duration according to the measurement data of the gyroscope, and determining the lens attitude corresponding to the region exposure time point of each planimetric image region from the lens attitude change trend.

13. The image generation apparatus according to claim 9, wherein the planimetric image region correction module further configured to:
transforming the planimetric position coordinate of each planimetric image region into a spherical position coordinate of a corresponding spherical image region according to parameters of the taking lens;
correcting the spherical position coordinate of the corresponding spherical image region according to the lens attitude of the taking lens at the region exposure time point and the lens attitude of the taking lens at the intermediate time point of image exposure;
transforming the corrected spherical position coordinates of the spherical image regions into the corrected planimetric position coordinates of the planimetric image regions.

14. The image generation apparatus according to claim 13, wherein the planimetric image region correction module configured to:
transforming the planimetric position coordinate of each planimetric image region into a spherical position coordinate of a corresponding spherical image region through the following formulas:
$$r = \sqrt[2]{{( x - cx )}^{2} + {( y - cy )}^{2}} ;$$
$${θ}_{d} = \frac{r}{focal} ;$$
$$θ = undistort ( {θ}_{d} ) ; \\ [ \begin{matrix}X \\ Y \\ Z\end{matrix} ] = [ \begin{matrix}sin θ * \frac{x - cx}{r} \\ sin θ * \frac{y - cy}{r} \\ cos θ\end{matrix} ] ;$$
wherein (x, y) is the planimetric position coordinate of each planimetric image region; (X, Y, Z) is the spherical position coordinate of the corresponding spherical image region; (cx, cy) is a center point coordinate of the corresponding spherical image region; undistort is a distortion correction function; and focal is a calibration focal length of the taking lens.

15. The image generation apparatus according to claim 13, wherein the planimetric image region correction module configured to:
correcting the spherical position coordinate of the corresponding spherical image region through the following formulas:
$$[ \begin{matrix}\hat{X} \\ \hat{Y} \\ \hat{Z}\end{matrix} ] = {R}_{c} {R}_{k}^{T} [ \begin{matrix}X \\ Y \\ Z\end{matrix} ] ;$$
wherein (X, Y, Z) is the spherical position coordinate of the corresponding spherical image region; (\hat{X}, Ŷ, \hat{Z}) is the corrected spherical position coordinate of the corresponding spherical image region; R_{c} is a lens attitude matrix of the taking lens at the intermediate time point of image exposure; and Rₖ is a lens attitude matrix of the taking lens at the region exposure time point.

16. The image generation apparatus according to claim 13, wherein the planimetric image region correction module configured to:
transforming the corrected spherical position coordinates of the spherical image regions into the corrected planimetric position coordinates of the planimetric image regions through the following formulas:
$$θ = {tan}^{- 1} \frac{\sqrt[2]{{\hat{X}}^{2} + {\hat{Y}}^{2}}}{\hat{Z}} ;$$
$${θ}_{d} = distort ( θ ) ;$$
$$r = focal * {θ}_{d} ; \\ [ \begin{matrix}\hat{x} \\ \hat{y}\end{matrix} ] = r * [ \begin{matrix}\frac{\hat{X}}{\sqrt[2]{{\hat{X}}^{2} + {\hat{Y}}^{2}}} \\ \frac{\hat{Y}}{\sqrt[2]{{\hat{X}}^{2} + {\hat{Y}}^{2}}}\end{matrix} ] + [ \begin{matrix}cx \\ cy\end{matrix} ] ;$$
wherein (\hat{x}, ŷ) is the corrected planimetric position coordinate of each planimetric image region; (\hat{X}, Ŷ, \hat{Z}) is the corrected spherical position coordinate of the corresponding spherical image region; (cx, cy) is a center point coordinate of the corresponding spherical image region;
distort is a distortion function; and focal is a calibration focal length of the taking lens.

17. A computer-readable storage medium having a processor executable instruction stored therein, wherein the instruction is loaded by one or more processors to execute an image generation method comprising the following steps:
acquiring a planimetric taken input image, and segmenting the planimetric taken input image into a plurality of planimetric image regions, wherein each planimetric image region includes a planimetric position coordinate used for indicating a position of the planimetric image region in the planimetric taken input image;
acquiring a region exposure time point of each planimetric image region and a lens attitude of a corresponding taking lens at the region exposure time point;
correcting the planimetric position coordinate of each planimetric image region according to the lens attitude of the taking lens at the region exposure time point and a lens attitude of the taking lens at an intermediate time point of image exposure; and
generating a planimetric taken output image based on the corrected planimetric position coordinates of the planimetric image regions.
